(19) United States
(12) Patent Application Publication
(10) Pub. No.: US 2008/0120452 A1
(43) Pub. Date: May 22, 2008

(54) LASER POINTER

(75) Inventor: SZU-WEI KUO, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/615,021

(22) Filed: Dec. 22, 2006

(30) Foreign Application Priority Data
Nov. 17, 2006 (CN) 200610156896.8

(51) Int. Cl. H01S 3/02

(52) U.S. Cl. 710/301; 372/38.03

(57) ABSTRACT

In one preferred embodiment, a laser pointer includes a connector for connecting the laser pointer to a computer, a regulator connected to the connector for regulating a voltage from the computer, a voltage converting circuit connected to the regulator for converting the voltage from the computer to a needed voltage, a charging circuit receiving the needed voltage, a rechargeable cell charged by the charging circuit, a switch, and an output circuit connected to the rechargeable cell via the switch for outputting laser light. When the laser pointer runs out of power, the notebook computer may charge the laser pointer. It is convenient and economical.

### BACKGROUND OF THE INVENTION

1. Field of the Invention

The present invention relates to a pointer, and more particularly to a laser pointer.

2. Description of Related Art

During a process of a meeting, a laser pointer is used for pointing to special content in a briefing. The laser pointer is provided power by a battery. However, if the laser pointer is used for a long time, more than one battery must be prepared before the meeting. It is a waste of time and inconvenient to prepare several batteries beforehand to change the battery in pointer during the meeting.

What is desired, therefore, is a laser pointer which is convenient and economical.

### SUMMARY OF THE INVENTION

In one preferred embodiment, a laser pointer includes a connector for connecting the laser pointer to a computer, a regulator connected to the connector, and regulating a voltage from the computer, a voltage converting circuit connected to the regulator, and converting the voltage from the computer to a needed voltage, a charging circuit receiving the needed voltage, a rechargeable cell charged by the charging circuit, a switch, and an output circuit connected to the rechargeable cell via the switch for outputting laser light.

Other advantages and novel features will become more apparent from the following detailed description of preferred embodiments when taken in conjunction with the accompanying drawings, in which:

### BRIEF DESCRIPTION OF THE DRAWINGS

FIG. 1 is an isometric view of a laser pointer in accordance with a preferred embodiment of the present invention;

FIG. 2 is an isometric view of FIG. 1 from an opposite direction;

FIG. 3 is a block diagram of one embodiment of an indicating circuit of FIG. 1; and

FIG. 4 is an isometric view of the laser pointer of FIG. 1, together with a notebook computer.

### DETAILED DESCRIPTION OF THE INVENTION

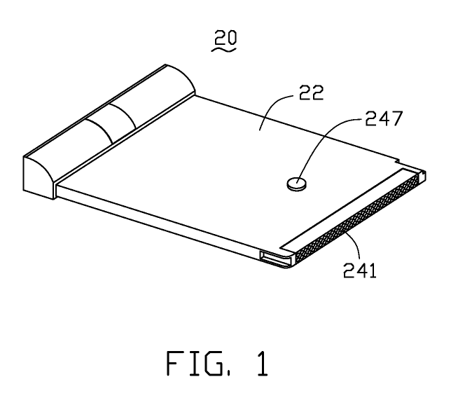

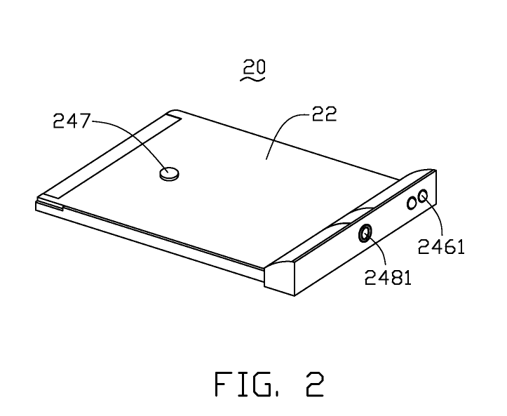

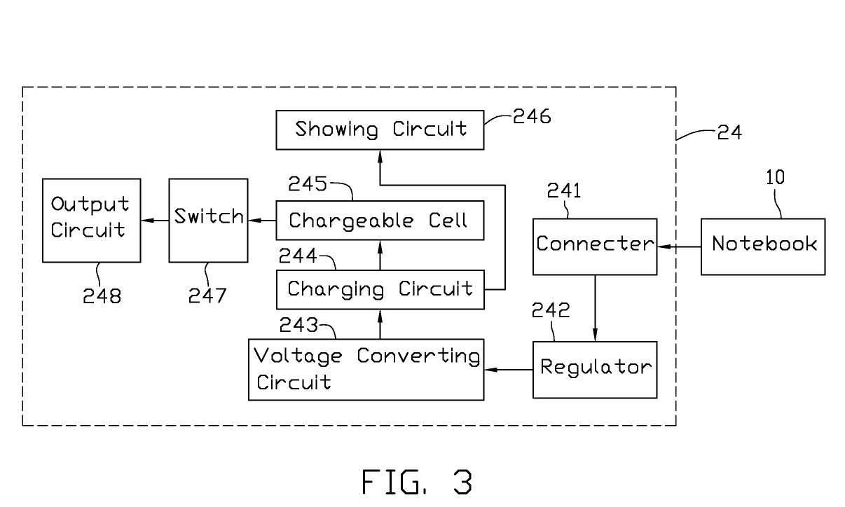

As shown in FIG. 1 to FIG. 3, in a preferred embodiment of the present invention, a laser pointer includes a shell 22 and an indicating circuit 24 mounted in the shell 22. The indicating circuit 24 includes a connector 241, a regulator 242, a DC to DC voltage converting circuit 243, a charging circuit 244, a rechargeable cell 245, an showing circuit 246 for indicating whether a charging process of the rechargeable cell 245 has been completed, a switch 247, and an output circuit 248. The output circuit 248 includes a device, for example, a laser diode 2481, which may emit laser light. The showing circuit 246 includes a light emitting diode (LED) 2461. The connector 241 is mounted on one end of the shell 22. The LED 2461 and the laser diode 2481 are mounted on an opposite end of the shell 22. The switch 247 is mounted on a top side of the shell 22. In the embodiment, the connector 241 employs a PCMCIA (Personal Computer Memory Card International Association) interface, and the switch 247 is a manual switch. Additionally, the connector 241 may employ another interface.

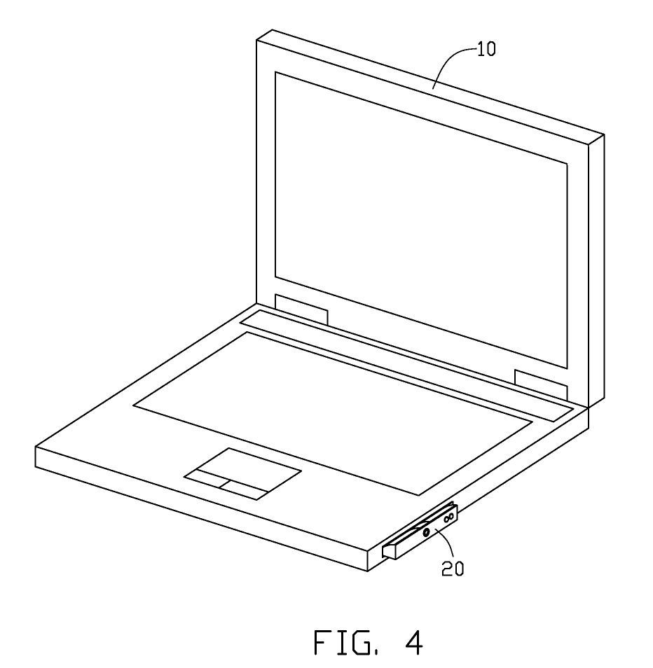

Referring also to FIG. 4, the connector 241 can be connected to a computer, for example, a notebook computer 10. The regulator 242 regulates a voltage from the notebook computer 10 via the connector 241, and provides a regulated voltage to the voltage converting circuit 243. The voltage converting circuit 243 converts the regulated voltage to a needed voltage. The charging circuit 244 receives the needed voltage and charges the rechargeable cell 245. The showing circuit 246 is connected to the charging circuit 244. When the charging circuit 244 is charging, the LED 2461 of the showing circuit 246 is on. When the charging process is completed, the LED 2461 turns off. The output circuit 248 is connected to the charging cell 245 via the switch 247. When the switch 247 is pressed, the laser diode 2481 emits laser light. When the switch 247 is released, the laser diode 2481 turns off.

When the rechargeable cell 245 runs out of power, the connector 241 of the laser pointer 20 is inserted into a PCI card slot of the notebook computer 10 to charge the rechargeable cell 245 turning on the LED 2461 indicating the rechargeable cell 245 is charging. When the LED 2461 turns off, the laser pointer 20 is ready for use.

During a meeting process nowadays, a computer, particularly a notebook computer is widely used. If the laser pointer 20 runs out of power, the notebook computer may charge the laser pointer 20. Thus, users need not prepare additional batteries for the laser pointer 20. It is convenient and economical.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A laser pointer comprising:
a connector connected to a computer;
a regulator connected to the connector, and regulating a voltage from the computer;
a voltage converting circuit connected to the regulator, and converting the voltage from the computer to a needed voltage;
a charging circuit receiving the needed voltage;
a rechargeable cell charged by the charging circuit;
a switch; and
a laser output circuit connected to the rechargeable cell via the switch for outputting laser light.

2. The laser pointer as claimed in claim 1, further comprising an showing circuit connected to the charging circuit for indicating whether a charging process is completed.

3. The laser pointer as claimed in claim 2, wherein the showing circuit comprises a light emitting diode (LED) which turns on when the charging circuit is charging the rechargeable cell.

4. The laser pointer as claimed in claim 1, wherein the laser output circuit comprises a laser diode.

5. The laser pointer as claimed in claim 1, further comprising a shell, the connector is mounted on one end of the shell, the switch is mounted on a top side of the shell, the regulator, the charging voltage circuit, the rechargeable cell, and the output circuit are mounted in the shell.

6. A computer assembly comprising:
a computer comprising a PCI card slot; and
a laser pointer insertable into the PCI card slot of the computer, the laser pointer comprising:
a connector at one end thereof to receive a voltage from the computer;
a regulator connected to the connector, and regulating the voltage from the computer;
a voltage converting circuit connected to the regulator, and converting the voltage from the computer to a needed voltage;
a charging circuit receiving the needed voltage;
a rechargeable cell charged by the charging circuit;
a switch; and
a laser output circuit connected to the rechargeable cell via the switch for outputting laser light.

7. The computer assembly as claimed in claim 6, further comprising an showing circuit connected to the charging circuit for indicating whether a charging process is completed.

8. The computer assembly as claimed in claim 7, wherein the showing circuit comprises a light emitting diode (LED).

9. The computer assembly as claimed in claim 6, wherein the laser output circuit comprises a laser diode.

10. The computer assembly as claimed in claim 6, further comprising a shell, wherein the connector is mounted on one end of the shell, the switch is mounted on a top side of the shell, the regulator, the charging voltage circuit, the rechargeable cell, and the output circuit are mounted in the shell.

11. A computer assembly comprising:
a computer comprising a PCI card slot; and
a laser pointer comprising:
a shell;
a connector installed at one end of the shell and inserted into the PCI card slot for receiving a voltage from the computer;
a regulator connected to the connector for regulating the voltage from the computer;
a voltage converting circuit connected to the regulator for converting the regulated voltage to a needed voltage;
a charging circuit receiving the needed voltage;
a rechargeable cell charged by the charging circuit;
a switch accessible from outside of the shell; and
a laser output circuit connected to the rechargeable cell via the switch for outputting laser light.

12. The computer assembly as claimed in claim 11, further comprising an showing circuit connected to the charging circuit for indicating whether a charging process is completed.

13. The computer assembly as claimed in claim 11, wherein the laser output circuit comprises a laser diode installed at an opposite end of the shell.
